(19) United States
(12) Patent Application Publication
(10) Pub. No.: US 2023/0360154 A1
(43) Pub. Date: Nov. 9, 2023

(54) LIVE WALKTHROUGH PLATFORM

(71) Applicant: Zero Street LLC, Long Island City, NY (US)

(72) Inventors: Eric Benaim, Long Island City, NY (US); Arlinda Dine, Astoria, NY (US)

(21) Appl. No.: 18/198,972

(22) Filed: May 18, 2023

Related U.S. Application Data
(60) Provisional application No. 63/338,755, filed on May 5, 2022.

(51) Int. Cl. G06Q 50/16; H04N 21/2187; G06T 19/00; H04L 51/046

(52) U.S. Cl. CPC G06Q 50/16; H04N 21/2187; G06T 19/006; H04L 51/046

(57) ABSTRACT

A platform for conducting a live stream walkthrough of a real estate property is provided. The real estate property may be any suitable property. The real estate property may be a residential property. The real estate property may be a commercial property. The real estate property may be vacant or undeveloped land.

### BACKGROUND

There is a need for live curating of real estate property in a manner that is accessible to prospective purchasers or renters that are remote from the physical location of the property. In recent years working from home has become more prevalent and properties are now serving as both living and working space. Purchasers and renters now have more complex needs for what they desire in a property.

On the other hand, purchasers and renters because they are now increasingly comfortable conducting business remotely, they may not wish to travel to visit a property in person. Additionally, purchasers and renters may wish to consider a real estate property that is located far away from their current residence. Their jobs may not require location in a specific geographic location, and this opens up distant locations as realistic living locations. Purchasers or renters are now able to consider more diverse locations because of the ability to work remotely.

It may not be practical for purchasers or renters to travel to all possible locations they are considering. Real estate purchases, rentals or leases are typically big-ticket items and require careful consideration beforehand. For example, in April 2022, the U.S. Department of Housing and Urban Development reported that the average sales price for a new single-family house in the United States was $523,900.

Therefore, it would be desirable to provide a platform that allows purchasers or renters to view a real estate property from any location. It would further be desirable to provide a platform for purchasers or renters to interact with an agent curating a property while the agent is physically located on the property. Therefore, it is desirable to provide apparatus and methods for a LIVE STREAM WALKTHROUGH PLATFORM.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram in accordance with principles of the disclosure;

FIG. 2 shows another illustrative diagram in accordance with principles of the disclosure; and

FIG. 3 shows yet another illustrative diagram in accordance with principles of the disclosure.

### DETAILED DESCRIPTION

A platform for conducting a live stream walkthrough of a real estate property is provided. The real estate property may be any suitable property. The real estate property may be a residential property. The real estate property may be a commercial property. The real estate property may be vacant or undeveloped land.

The platform may include one or more computer systems. A computer system can be configured to perform particular operations or actions by virtue of having software, firmware, hardware, or a combination of them installed on the computer system that in operation causes the computer system to perform the particular operations or actions.

Software may be made up of multiple modules. A software module is a component of the software that is responsible for performing a target operation or action. The software and its associated modules may be executed on a computer system. The computer system may include a mobile device such as a smart phone or tablet. The computer system may include a remote computer system.

The computer system may include a network connected computer system. Network connected systems may be portable devices such as a laptop, tablet, smartphone, other “smart” devices (e.g., watches, eyeglasses, clothing having embedded electronic circuitry) or any other suitable device for receiving, storing, transmitting and/or displaying electronic information.

A computer system, as disclosed herein, may include a processor circuit. The processor circuit may control overall operation of the computer system and its associated components. The processor circuit may include hardware, such as one or more integrated circuits that form a chipset. The hardware may include digital or analog logic circuitry configured to perform any suitable (e.g., logical) operation.

For example, a computer system may include one or more of the following hardware components: I/O circuitry, which may include a transmitter device and a receiver device and may interface with fiber optic cable, coaxial cable, telephone lines, wireless devices, physical network layer hardware, a keypad/display control device or any other suitable encoded media or devices; peripheral devices, which may include counter timers, real-time timers, power-on reset generators or any other suitable peripheral devices; a logical processing device, which may compute data structural information, structural parameters of the data, or video resolution, audio sampling or any other processing task necessary to broadcast a live stream walkthrough; and machine-readable memory.

Machine-readable memory may be a non-transitory media. The machine-readable memory configured to store, in machine-readable data structures: software modules or any other suitable information or data structures. Components of the computer system may be linked by a system bus, wirelessly or by other suitable interconnections. Computer system components may be present on one or more circuit boards. In some embodiments, the components may be integrated into a single chip. The chip may be silicon-based.

The computer system may include RAM, ROM, an input/output (“I/O”) module and a non-transitory or non-volatile memory. The I/O module may include a microphone, button and/or touch screen which may accept user-provided input. The I/O module may include one or more of a speaker for providing audio output and a video display for providing textual, audiovisual and/or graphical output. A computer system may include various other components, such as a display, battery, speaker, and antennas.

Software modules may be stored within the non-transitory memory and/or other storage medium. Software modules may provide instructions to the processor that enable the computer system to perform various operations or actions. For example, the non-transitory memory may store software modules such as an operating system, application programs, and an associated database. Some or all of computer executable instructions may be embodied in hardware or firmware components of the computer system.

A computer system may include cloud computing and virtualization implementations of software. Such implementations may be designed to run on a physical server supplied externally by a hosting provider, a client, or other virtualized platforms. Software application programs, which may be used by the computer system, may include computer executable instructions for invoking user functionality related to communication, such as email, short message service (“SMS”), and voice input and speech recognition applications.

A computer system may include a communication circuit. The communication circuit may include a network interface card or adapter. When used in a WAN networking environment, a computer system may include a modem, antenna or other circuitry for establishing communications over a WAN, such as the Internet. The communication circuit may include a modem and/or antenna. The existence of any of various well-known protocols such as TCP/IP, Ethernet, FTP, HTTP and the like is presumed, and the server may be operated in a client-server configuration to permit retrieval of web pages from a web-based server. Web browsers can be used to display and manipulate data on web pages.

A computer system may include, and may be operational with, numerous other general purpose or special purpose computing system environments or configurations. Examples of well-known computing systems, environments, and/or configurations that may be suitable for use with this disclosure include, but are not limited to, personal computers, server computers, handheld or laptop devices, tablets, “smart” devices, mobile phones, multiprocessor systems, minicomputer systems, microprocessor systems, mainframe computers, distributed computing environments that include any of the above systems or devices, and the like.

A computer system may utilize computer-executable instructions, such as software modules, executed by a processor. Generally, software modules include routines, programs, objects, components, data structures, etc. that perform particular tasks or implement abstract data types. A computer system may be operational with distributed computing environments where tasks are performed by remote processing devices that are linked through a communications network. In a distributed computing environment, software modules may be located in both local and remote computer storage media including memory storage devices. A computer system may rely on a network of remote computer systems hosted on the Internet to store, manage, and process data (e.g., “cloud computing” and/or “fog computing”).

A computer system disclosed herein may be produced by different manufacturers. A computer system may capture data in different formats. A computer system may use different data structures to store captured data. A computer system may utilize different communication protocols to transmit captured data or communicate with other systems. Despite such operational differences, computer systems may be configured to operate substantially seamlessly to implement functionality of software modules executed by different systems operating systems, hardware or networks.

The platform may include a viewer portal. The viewer portal may include software, that when run on a computer system, provides functionality to a purchaser of the real estate property. A “purchaser” as used herein may refer to anyone interested in a real estate property. An exemplary purchaser may include a potential buyer, potential tenant (e.g., renter or lessee), a curious passersby or neighbor or a real estate agent. The viewer portal may be an application installed on a mobile device of the purchaser. The viewer portal may be run on a remote or cloud-based computer system and accessible to the purchaser via a web browser or other application.

The viewer portal may allow the purchaser to view a live stream walkthrough. Using the viewer portal, the purchaser may tune in to and view the live stream walkthrough from a location that is remote from the real estate property being showcased in the live stream walkthrough. The platform may allow multiple purchasers to concurrently view the live stream walkthrough. For example, each purchaser may install an application that includes the viewer portal on their mobile device. Each purchaser may user a web browser to navigate to a link that provides viewing access to broadcast of a live stream walkthrough.

The live stream walkthrough may include a live video broadcast. The video content may be captured live by one or more cameras onsite at the real estate property. The live stream walkthrough may include a live audio broadcast. The video may be captured live by one or more microphone onsite at the real estate property.

The live stream walkthrough may include a live broadcast of a tour or demonstration of a real estate property. An agent may conduct the tour or demonstration of the real estate property. An “agent” may refer to anyone interested in educating the public about the real estate property. The agent may host a live stream walkthrough. An exemplary agent may include an owner of the property, a property manager or a real estate agent.

The live stream walkthrough may be a live broadcast of an “open house” showcasing a real estate property. For example, an agent may be onsite at a real estate property. During the live stream walkthrough, the agent may welcome purchasers viewing the live stream walkthrough to the property and offer to walk the purchasers through the property or show the purchasers specific features of the property. As will be discussed below, a purchaser viewing a live stream walkthrough may request that the agent show a specific feature of the property. In response to such a request, the onsite agent may move a camera so that the requested feature is shown on the live stream walkthrough.

During the live stream walkthrough an agent may show, describe and demonstrate features and fixtures of the real estate property. Illustrative fixtures may include appliances, lights, alarm system, cameras, beds, furniture and other household items. Illustrative features may include are number of bedrooms, number of bathrooms, type of bathrooms (e.g., full or half), bed size, balcony type, staircases and associated dimensions, size of rooms layout of a structure or any other suitable information about a real estate property.

Other exemplary features of a real estate property that may be showcased by the agent during a live stream walkthrough include ceilings and areas under sinks. The curating agent may show which direction windows face for sunlight to enter or whether there is a pleasant view when looking out of the windows. The curating agent may show locations and number of electrical outlets or ground fault circuit interrupters in the kitchen and bathrooms. The curating agent may show areas under throw rugs, behind large artwork, and behind trash cans against the outside of the house.

The platform may include an agent portal. The agent portal may include software, that when run on a computer system, provides functionality to an agent conducting the tour or demonstration of the real estate property. The agent portal may be an application installed on a mobile device of the agent. The agent portal may be run on a remote or cloud-based computer system and accessible to the agent via a web browser or other application.

The agent portal may allow the agent to capture audio and video content. The agent portal may allow the agent to broadcast the captured audio and video content as a live stream walkthrough showcasing the real estate property. The agent portal may allow the agent, during the live stream walkthrough to receive an inquiry from a purchaser viewing the live stream walkthrough. The agent portal may allow the agent to conduct a private chat with a purchaser during the live stream walkthrough.

The agent may be a first agent. The live stream walkthrough may be a first live stream walkthrough. The agent portal may provide functionality that allows a second agent to broadcast a second live stream walkthrough that showcases the real estate property also being shown in the first live stream walkthrough. The first live stream walkthrough and the second live stream walkthrough may be broadcast simultaneously from the real estate property.

The agent portal may be configured to guide the first agent though the real estate property during the first live stream walkthrough. For example, the agent portal may issue instructions to the agent such as which room to showcase or how to navigate through the real estate property. The agent portal may provide a teleprompter function which presents the agent, during broadcast of the live stream walkthrough, with a script that describes a room, feature, fixture or other aspect of the real estate property.

The platform may track a current location of the agent in the real estate property. For example, the agent portal may be installed on a mobile device of the agent and use location services of the mobile device to track a current location of the agent. During the live stream walkthrough, the teleprompter function may prompt the agent to discuss and show features of the real estate property in or based on the current location of the agent.

The platform may guide (e.g., via the agent portal or teleprompter module) one or more agents through the real estate property during broadcast of the one or more live stream walkthroughs. For example, the platform may track a location of first and second agents within the real estate property. The platform may coordinate movements of the first and second agents such that the first live stream walkthrough (hosted by the first agent) does not interfere with the second live stream walkthrough (hosted by the second agent). The platform may issue navigation instructions to the first agent (e.g., via an agent portal installed on a mobile device of the first agent) such that the first agent does not enter a room while the room is being showcased and broadcast on live stream walkthrough hosted by the second agent.

The platform may include a search module. The search module may include software, that when run on a computer system, provides functionality that allows a purchaser to search for a target real estate property from among a plurality of real estate properties. T plurality of real estate properties may be stored in an associated database. The search module may allow the purchaser to search for the target real estate property based on whether a live stream walkthrough has been scheduled for the target real estate property or other criteria.

In some embodiments, a broadcast of a live stream walkthrough may be initiated by an agent when the agent is physically present on the real estate property. In some embodiments, a live stream walkthrough may be generated and broadcast without an agent being physically present on the real estate property.

A live stream walkthrough may include video content showing features of the real estate property. A live stream walkthrough may include audio content describing features of the real estate property. A live stream walkthrough may include video content captured from one or more security cameras installed at the real estate property. A live stream walkthrough may include a pre-recorded video showing features of the real estate property. A live stream walkthrough may include a pre-audio describing features of the real estate property.

The live stream walkthrough may include video content captured by a camera mounted on a robot. The robot may be programmed to navigate the real estate property autonomously during broadcast of the live stream walkthrough. Video (and audio) content captured by the robot may be broadcast during the live stream walkthrough. The robot may be a flying drone. The agent hosting live stream walkthrough may add audio content to the live stream walkthrough from a remote location.

The platform may insert an avatar into video content broadcast during the live stream walkthrough. The platform may move the avatar during broadcast of the live stream walkthrough. The movement of the avatar during the live stream walkthrough may represent movement of the agent within the real estate property. The movement of the avatar may be coordinated to represent movement of an agent curating the real estate property and hosting the live stream walkthrough. The movement of the avatar may be coordinated to represent movement of what a live agent would do to when curating features of the real estate property currently being shown in video content broadcast during the live stream walkthrough.

In some embodiments a drone may be programmed to follow a live agent as the agent showcases the real estate property during a live stream walkthrough. The drone may include a camera that captures video, audio or other content. The drone may be programmed to follow an agent hosting the live stream walkthrough as the agent moves through the real estate property and showcases features of the property.

The drone may be responsive to motion of the agent. The drone may navigate through the real estate property and/or follow the agent based on the motion of the agent. For example, the drone may be response to hand motions of the agent. When the agent points as a fixture or other feature of the property, the camera mounted on the drone may focus on the fixture or feature.

The platform may include a scheduling module. The scheduling module may include software, that when run on a computer system, provides functionality that allows multiple live stream walkthroughs to be scheduled for a real estate property. Each of the multiple live stream walkthroughs may be scheduled by a different agent. The scheduling module may prevent two live stream walkthroughs from being scheduled at the same time for the same real estate property.

In response to receiving a start time for a first live stream walkthrough, the scheduling module may be configured to prevent a second live stream walkthrough from being scheduled a threshold amount of time after the start time. The threshold amount of time may be determined based on an at least one feature of the real estate property. The threshold amount of time may be an estimated amount of time needed to showcase the at least feature. The threshold amount of time may be an estimated amount of time needed to showcase the entire real estate property.

The scheduling module may be configured to detect a request to schedule a second live stream walkthrough during a time that overlaps with an expected duration of a first live stream walkthrough. In response to detecting a scheduling request that overlaps with the expected duration of the first live stream walkthrough, the scheduling module may initiate an override procedure. The override procedure may allow for a second live stream to be scheduled during a time that overlaps with the expected duration of the first live stream walkthrough.

The scheduling module may allow a second live stream walkthrough to be scheduled at the time that overlaps with the expected duration of a first live stream walkthrough in response to detecting a threshold number of requests to view the real estate property. For example, if the platform receives more than a threshold number of purchaser requests to view the real estate property, the scheduling module may allow multiple live stream walkthroughs to be scheduled concurrently. Each of the multiple live stream walkthroughs may be hosted by a different agent.

The viewer portal may allow a purchaser viewing live stream walkthrough to tag a feature or fixture of the real estate property shown during the live stream walkthrough. For example, when viewing the live stream walkthrough on a device with a touch screen, the purchaser may tag a feature by touching (e.g., a long touch or double tap) an area of the touch screen. The platform may be configured to correlate the touched area of the screen to a feature or fixture being shown in the live stream walkthrough and tag that feature or fixture.

Tagging a feature or fixture may initiate an interactive chat dialogue with the hosting agent. Tagging the feature or fixture may initiate a chat function on the viewer and agent portals. Tagging the feature or fixture may trigger a display, on a purchaser device, of additional details associated with the tagged feature or fixture. Such illustrative details may include dimensions of a room, features of a bathroom or kitchen, or possible configuration options for furniture in a room.

The additional details displayed to a purchaser may include an augmented reality view of the tagged feature or fixture. An augmented reality module may superimpose computer-generated material over a tagged feature or fixture shown in the live stream walkthrough. For example, the computer-generated content may show the inside of a tagged refrigerator or show what is behind a tagged door.

The viewer portal may be installable as an app on a mobile device. The agent portal may be installable as an app on a mobile device. The viewer portal may allow a purchaser to submit a bid to purchase the real estate property during a viewing of a live stream walkthrough. “Purchase” as used herein may include acquiring rights to use the real estate property. An illustrative “purchase” may include renting, licensing, leasing or buying the real estate property. The agent portal may allow an agent to accept the bid or other purchaser offer. The agent portal may an agent to accept the bid or other purchaser offer during or after the live stream walkthrough.

A platform for broadcasting a live stream walkthrough of a real estate property is provided. The platform may include instructions stored on a non-transitory memory. The instructions, when executed by a processor on a computer system may implement functions of the platform. The computer system may include a mobile device such as a smart phone or tablet. The computer system may include a remote computer system.

The platform may broadcast a live stream walkthrough of a real estate property. The live stream walkthrough may include live showcasing of the real estate property by an agent. The platform may allow a purchaser to watch the live stream walkthrough. The platform may allow the agent to conduct an interactive chat dialogue with the purchaser without interrupting the viewing of the live stream walkthrough by the purchaser.

The platform may allow the purchaser viewing the live stream walkthrough to privately chat and/or message with the agent or other host of the live stream walkthrough. During the live stream walkthrough, a private message button or direct message button may be presented to the purchaser. When the purchaser activates (e.g., by click or touch) the private or direct message button, a display showing the ongoing live stream walkthrough may be minimized. A chat window may be opened so that while the live stream walkthrough is ongoing, the purchaser can privately message the agent hosting the live stream walkthrough without any other purchasers who are viewing the live stream seeing the private message.

The platform may allow an agent to schedule a live stream walkthrough. The platform may allow a purchaser to sign up to watch the scheduled live stream walkthrough. The platform may transmit a notification to the purchaser before the scheduled time for broadcast of the live stream walkthrough. The platform may integrate scheduling information associated with a live stream walkthrough into a personal calendar for other appointments and reminders of the purchaser or agent. Scheduling information may include time, date and expected duration of a live stream walkthrough. Scheduling information may include a uniform resource locator (“URL”) or other credentials for accessing and viewing the live stream walkthrough at the scheduled time.

The platform may provide a filter that allows a purchaser to sort a plurality of real estate properties based on at least one preference. The at least one preference may include: a purchase budget, a move in date, a bed size, a number of bathrooms, a balcony type, a city, a geographic area, an amenity and any other suitable criteria that helps the purchaser locate a target real estate property.

The platform may allow the purchaser to watch the live stream walkthrough, and while viewing the live stream walkthrough, apply to purchase the real estate property. Implementations of the described techniques may include hardware, a method or process, or computer software on a computer-accessible medium.

Methods for showcasing a real estate property are provided. Implementations of the described techniques may include hardware, a method or process, or computer software on a computer-accessible medium. Other embodiments of this aspect include corresponding computer systems, apparatus, and computer programs recorded on one or more computer storage devices, each configured to perform the actions of the methods.

Methods may include scheduling a live stream walkthrough of a real estate property. Methods may include transmitting an alert informing a purchaser of a scheduled start time for a live stream walkthrough. Methods may include initiating the live stream walkthrough at the scheduled start time.

Methods may include receiving a question from a purchaser during broadcast of a live stream walkthrough. Methods may include receiving a question from a purchaser while the purchaser is viewing the live stream walkthrough. In response to receiving the question, methods may include initiating a private chat with the purchaser. The private may not pause or otherwise interrupt the ongoing live stream walkthrough. The private may not pause or otherwise interrupt the ongoing live stream walkthrough being viewed by the purchaser.

A real estate property may be one of a plurality of real estate properties. Methods may include filtering a plurality of real estate properties and identifying a subset of the plurality of real estate properties based on whether each member of the subset is associated with a scheduled live stream walkthrough. Methods may include filtering a plurality of real estate properties and identifying a subset of the plurality of real estate properties that are each associated with a set of purchaser entered preferences. Illustrative preference may include a purchase budget, a move in date, a bed size, a number of bathrooms, a balcony type, a city, a geographic area, an amenity and any other suitable criteria that helps the purchaser locate a target real estate property.

In response to viewer input received during the live stream walkthrough, methods may include initiating an augmented reality overlay. The augmented reality overlay may be associated with a feature of the real estate property identified based on purchaser input captured during the live stream walkthrough. The purchaser input may include a touch point captured from a purchaser device during the live stream walkthrough. For example, while viewing the live stream walkthrough on a mobile device, the purchaser may touch an area of interest currently being shown on a screen of the mobile device during the live stream walkthrough. The mobile device may include a touch sensitive screen.

Methods may include receiving, during a live stream walkthrough, an application from a purchaser to purchase the real estate property being shown in the live stream walkthrough. For example, the purchaser may access and submit an application to rent or lease the real estate property showcased in the live stream walkthrough. Methods may include providing the purchaser access to an application to purchase the real estate property. A viewer portal may provide access to a live stream walkthrough associated with a real estate property. The viewer portal may also provide access to such an application to purchase the real estate property. The viewer portal may be installed on a mobile device of the purchaser.

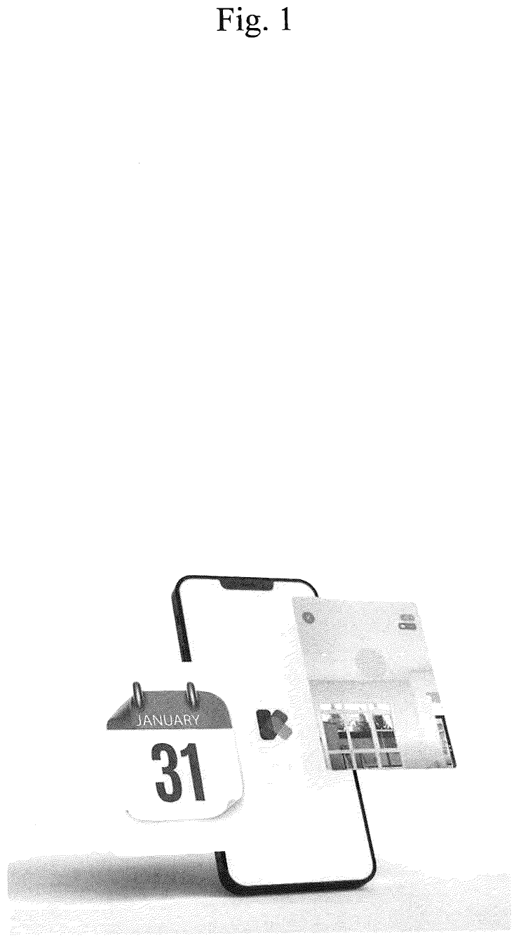

FIG. 1 (below) shows a conceptual screenshot of a calendar module. The calendar module may allow agents to schedule live stream walkthroughs for one or more real estate properties. The calendar module may allow purchasers to sign up to view a scheduled live stream walkthrough. The calendar module may transmit notifications to the purchaser before the scheduled live stream walkthrough begins. The calendar module may also integrate with a personal calendar for appointments and other reminders.

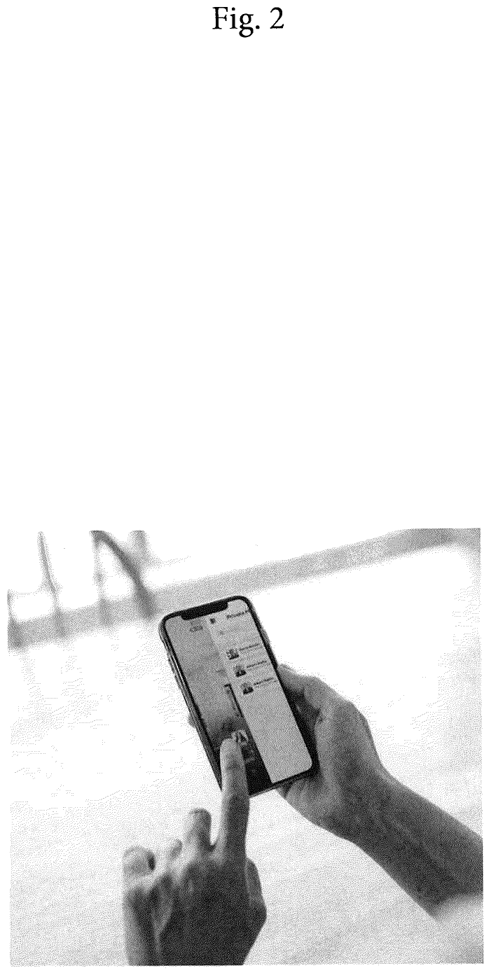

FIG. 2 (below) shows a conceptual screenshot of a chat function that may be provided during a live stream walkthrough by the platform described herein. The chat function may allow an interactive chat dialogue between an agent and purchaser. The interactive chat dialogue may be conducted during a live stream walkthrough. The interactive chat dialogue may not pause, stopping or otherwise interrupt broadcast of the live stream walkthrough for a viewing purchaser or hosting agent.

The chat function may provide functionality that is not available from conventional public commenting features provided during a live broadcast. The chat function described herein allows purchasers to privately submit questions and receive answers. Privately may refer to a dialogue that is not visible to any other viewer of the live stream walkthrough other than the purchaser that initiated the dialogue. Such a chat functionality is not provided by public commenting functionality.

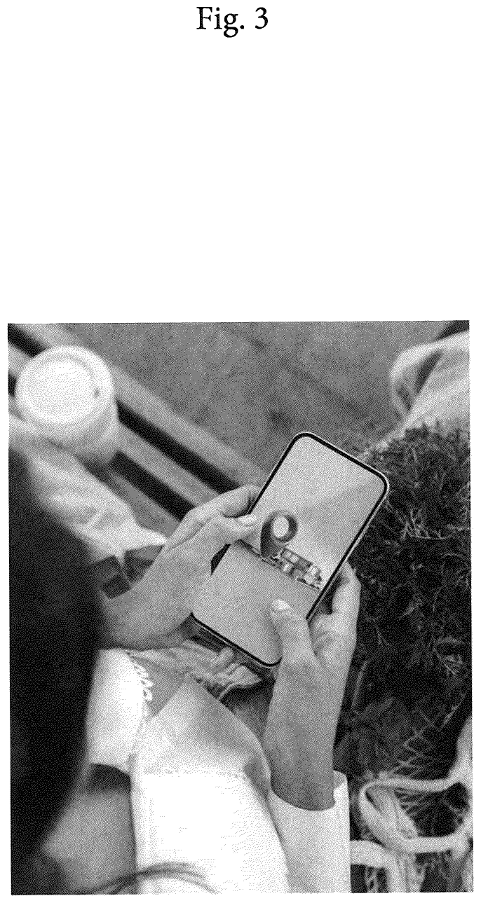

FIG. 3 (below) shows a conceptual screenshot of a filter function that may be provided by a platform described herein. The platform may allow purchasers to search listings of real estate properties. The filter function may allow the purchasers to sort the search results based on specific preferences. For example, the filter function may allow purchasers to sort search results based on budget, move in date, bed size, number of bathrooms, balcony type, city, area, amenities and other important information that will help the purchasers choose a real estate property wisely and more accurately.

The platform may include equipment for producing and broadcasting a live stream walkthrough. Illustrative equipment may include a device for capturing video and audio content. Video content may be captured using cameras, computers, and any other image capture devices. Audio content may be captured using a microphone, a mixer feed and any other audio capture devices.

Illustrative equipment may include mixing or switching devices that receive input from multiple video or audio capture devices. During broadcast of the live stream walkthrough, the mixing or switching devices may allow a host to alternate or combine (e.g., switch or mix) different sources of audio/video content. Illustrative equipment may include one or more encoders. An encoder may compress video or audio content so that the capture content is stored in a target file size, has a target resolution, a target format, a target sampling rate, or has any other desired property or technical attribute. Encoders may be software encoders or hardware encoders.

Illustrative equipment may include a gimbal and tripod. Illustrative equipment may include lights, such as a ring light. Illustrative equipment may include a distribution platform. An illustrative distribution platform may include a Content Delivery Network (“CDN”) that delivers video and audio content via the internet. Illustrative equipment may include a stable internet connection

Thus, methods and apparatus for LIVE WALKTHROUGH PLATFORM are provided. Persons skilled in the art will appreciate that the present disclosure can be practiced by other than the described embodiments, which are presented for purposes of illustration rather than of limitation. For example, although the LIVE WALKTHROUGH PLATFORM has been described in the context of real estate property, the platform may be used in other contexts as well.

Other illustrative contexts may include trade shows, entertainment and sporting events, educational conferences, and virtual events hosted in the metaverse. The live stream walkthrough may showcase how to navigate the venue hosting an event or may include an actual performance. Illustrative contexts may include a live stream shopping where the live stream walkthrough showcases products available for purchase. During the live stream walkthrough, viewers may buy a product featured in the live stream walkthrough and may engage in a private chat dialogue with a seller hosting the live stream walkthrough.

1. A platform for conducting a live stream walkthrough of a real estate property, the platform comprising:
a viewer portal that allows a purchaser to tune in to the live stream walkthrough from a location that is remote from the real estate property; and
an agent portal that allows an agent to:
broadcast the live stream walkthrough that showcases the real estate property; and
during the live stream walkthrough:
receive an inquiry from the purchaser; and
conduct a private chat with the purchaser.

2. The platform of claim 1, wherein the agent is a first agent, and the live stream walkthrough is a first live stream walkthrough, the agent portal allows a second agent to broadcast a second live stream walkthrough showcasing the real estate property.

3. The platform of claim 2, wherein the first live stream walkthrough and the second live stream walkthrough are broadcast simultaneously from the real estate property.

4. The platform of claim 2 wherein the agent portal is configured to:
guide the first agent though the real estate property to generate the first live stream walkthrough; and
guide the second agent through the real estate property to generate the second live stream walkthrough.

5. The platform of claim 4 wherein the agent portal coordinates movement of the first and second agents such that the first live stream walkthrough does not interfere with the second live stream walkthrough.

6. The platform of claim 1 further comprising a search module that allows the purchaser to search for a target real estate property from among a plurality of real estate properties based on whether the live stream walkthrough has been scheduled for the target real estate property.

7. The platform of claim 1 wherein the broadcast of the live stream walkthrough is initiated by the agent when the agent is physically present on the real estate property.

8. The platform of claim 1 wherein the live stream walkthrough is generated without the agent being physically present on the real estate property.

9. The platform of claim 8 wherein the agent portal is configured to insert an avatar into the live stream walkthrough to represent movement of the agent on the real estate property during the live stream walkthrough.

10. The platform of claim 1 further comprising a scheduling module that allows multiple live stream walkthroughs to be scheduled for the real estate property.

11. The platform of claim 10 wherein each of the multiple live stream walkthroughs are scheduled by a different agent.

12. The platform of claim 10 wherein the scheduling module prevents two live stream walkthroughs from being scheduled at the same time.

13. The platform of claim 10 wherein in response to receiving a start time for a first live stream walkthrough, the scheduling module is configured to prevent a second live stream walkthrough from being scheduled a threshold amount of time after the start time.

14. The platform of claim 13, wherein the threshold amount of time is determined based on an at least one attribute of the real estate property.

15. The platform of claim 10 wherein the scheduling module is configured to:
detect a request to schedule a second live stream walkthrough during a time that overlaps with an expected duration of a first live stream walkthrough; and
in response to detecting the request that overlaps with the expected duration of the first live stream walkthrough, initiate an override procedure for scheduling the second live stream at the time that overlaps with the expected duration of the first live stream walkthrough.

16. The platform of claim 15 wherein the scheduling module is configured to allow the second live stream walkthrough to be scheduled at the time that overlaps with the expected duration of the first live stream walkthrough in response to detecting a threshold number of requests to view the real estate property.

17. The platform of claim 1 wherein the viewer portal allows the purchaser to tag an area of the real estate property shown during the live stream walkthrough.

18. The platform of claim 17, wherein tagging the area initiates an interactive chat dialogue with the agent.

19. The platform of claim 17, wherein tagging the area triggers a display, on a device of the purchaser, of additional details associated with the tagged area.

20. The platform of claim 19, wherein the additional details comprise an augmented reality view of the tagged area.

21-50. (canceled)
